(19) United States
(12) Patent Application Publication
(10) Pub. No.: US 2025/0342200 A1
(43) Pub. Date: Nov. 6, 2025

(54) METHOD AND DEVICE FOR EDITING IMAGE IN ELECTRONIC DEVICE

(71) Applicant: Samsung Electronics Co., Ltd., Suwon-si (KR)

(72) Inventors: Joohyung LEE, Suwon-si (KR); Hyunsool KIM, Suwon-si (KR); Kwangjeung LEE, Suwon-si (KR); Yungjae LIM, Suwon-si (KR); Jeongheui CHO, Suwon-si (KR); Younghun JOO, Suwon-si (KR)

(21) Appl. No.: 19/265,927

(22) Filed: Jul. 10, 2025

Related U.S. Application Data
(63) Continuation of application No. PCT/KR2024/000486, filed on Jan. 10, 2024.

(30) Foreign Application Priority Data
Jan. 10, 2023 (KR) 10-2023-0003744
Feb. 9, 2023 (KR) 10-2023-0017491

(51) Int. Cl. G06F 16/51; G06F 16/583

(52) U.S. Cl. CPC G06F 16/51; G06F 16/583

(57) ABSTRACT

An electronic device comprises a memory and a processor connected to the memory. The memory can store instructions such that, when executed by the processor, causes the electronic device to: use information related to original data and a hash function to generate a value (unique value) based on edited data obtained by modifying the original data being stored in the memory; use the generated value to generate an original storage route for the original data; and generate original meta information including information about the original storage route and the hash function.

### CROSS-REFERENCE TO RELATED APPLICATIONS

This application is a continuation of International Application No. PCT/KR2024/000486 designating the United States, filed on Jan. 10, 2024, in the Korean Intellectual Property Receiving Office and claiming priority to Korean Patent Application Nos. 10-2023-0003744, filed on Jan. 10, 2023, and 10-2023-0017491, filed on Feb. 9, 2023, in the Korean Intellectual Property Office, the disclosures of each of which are incorporated by reference herein in their entireties.

### BACKGROUND

### Field

The disclosure relates to a technique for editing an image in an electronic device.

### Description of Related Art

Recently, electronic devices (e.g., mobile communication terminals, smartphones, tablet personal computers (PCs), notebooks, and/or digital cameras) have been used in various ways. Users edit images (e.g., still images and moving pictures) more frequently using electronic devices in daily life.

For example, a user may capture an image anywhere and/or anytime through a camera provided in an electronic device in daily life. In addition, the user may also receive an image through wireless communication and/or wired communication. After capturing or receiving the image, the user may edit the image through the electronic device in various ways.

The user may edit the image using various editing tools (e.g., image filter, color tone curve, contrast, brightness, sharpness, crop, and/or rotation change) included in an application installed in the electronic device.

### SUMMARY

According to an example embodiment, an electronic device may include: memory and at least one processor, comprising processing circuitry, connected to the memory. The memory may store instructions that, when executed by the at least one processor individually or collectively, cause the electronic device to, based on storing edited data obtained by modifying original data in the memory, generate a unique value using information related to the original data and a hash function; generate an original storage path for the original data using the generated unique value; and generate original meta information including the hash function and information about the original storage path.

According to an example embodiment, a method of operating an electronic device may include: based on the electronic device storing edited data obtained by modifying original data in memory, generating a unique value using information related to the original data and a hash function; generating an original storage path for the original data using the generated unique value; and generating original meta information including the hash function and information about the original storage path.

According to an example embodiment, in a non-transitory computer-readable storage medium storing at least one instruction, the at least one instruction, when executed by at least one processor, comprising processing circuitry, individually and/or collectively, of an electronic device, may cause an electronic device to perform operations comprising: based on the electronic device storing edited data obtained by modifying original data in memory, generating a unique value using information related to the original data and a hash function; generating an original storage path for the original data using the generated unique value; and generating original meta information including the hash function and information about the original storage path.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2 is a block diagram illustrating an example configuration of a program according to various embodiments;

FIG. 3 is a diagram illustrating an example of not applying a non-destructive editing function in an electronic device according to various embodiments;

FIG. 4 is a diagram illustrating an example of applying a non-destructive editing function in an electronic device according to various embodiments;

FIG. 5 is a diagram illustrating an example configuration of an electronic device including a non-destructive editing processor according to various embodiments;

FIG. 6 is a diagram illustrating an example operation of a non-destructive editing processor according to various embodiments;

FIG. 7 is a diagram illustrating an example in which an error occurs when a plurality of electronic devices use a non-destructive editing function according to various embodiments;

FIG. 8 is a diagram illustrating another example in which an error occurs when a plurality of electronic devices use a non-destructive editing function according to various embodiments;

FIG. 9 is a diagram illustrating an example of transmitting an edited image through a file transfer function during non-destructive editing in an electronic device according to various embodiments;

FIG. 10 is a diagram illustrating an example of transmitting an edited image through a third-party sharing application during non-destructive editing in an electronic device according to various embodiments;

FIG. 11 is a diagram illustrating an example of receiving only an edited image from a cloud server during non-destructive editing in an electronic device according to various embodiments;

FIG. 12 is a diagram illustrating an example in which an original image is deleted and only an edited image remains during non-destructive editing in an electronic device according to various embodiments;

FIG. 13 is a diagram illustrating an example configuration of an electronic device including a non-destructive editing processor and an original metadata manager according to various embodiments;

FIG. 14 is a flowchart illustrating an example operation of configuring original meta information during non-destructive editing in an electronic device according to various embodiments;

FIG. 15 is a flowchart illustrating an example operation of searching for an original file using original meta information in an electronic device or a server according to various embodiments;

FIG. 16 is a flowchart illustrating an example operation of obtaining an original path and storing an original file in an electronic device according to various embodiments;

FIG. 17 is a diagram illustrating an example operation of using a path based on original file information during non-destructive editing in a plurality of electronic devices according to various embodiments;

FIG. 18 is a diagram illustrating an example operation of using a path based on original file information during non-destructive editing in a plurality of electronic devices according to various embodiments;

FIG. 19 is a signal flow diagram illustrating an example operation of requesting an original file, when an electronic device holds only an edited file according to various embodiments; and

FIG. 20 is a flowchart illustrating an example operation of an electronic device according to various embodiments.

### DETAILED DESCRIPTION

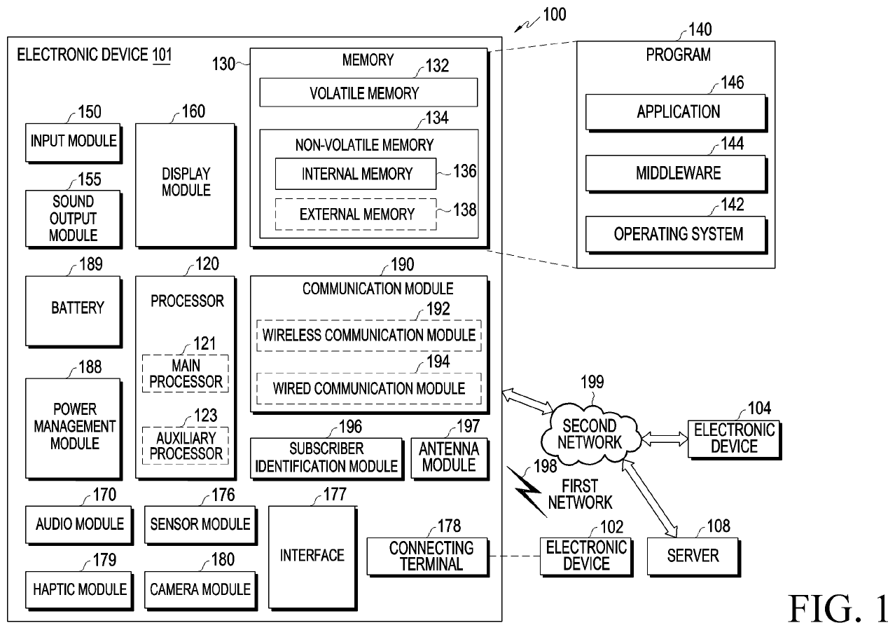

FIG. 1 is a block diagram illustrating an example electronic device in a network environment according to various embodiments.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one of the components (e.g., the connecting terminal 178) may be omitted from the electronic device 101, or one or more other components may be added in the electronic device 101. In an embodiment, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the strength of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam- forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form an mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1^{st}” and “2^{nd}”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

Embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

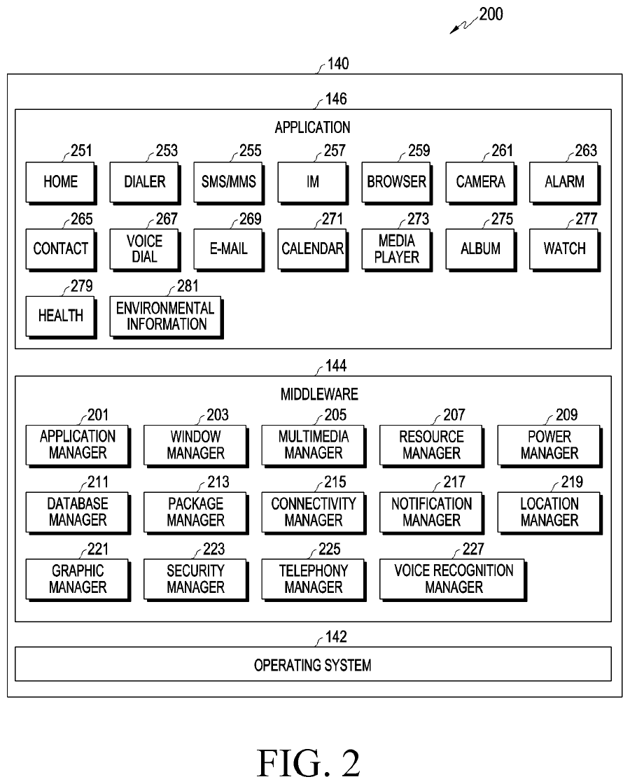

FIG. 2 is a block diagram 200 illustrating an example configuration of a program 140 according to various embodiments.

According to an embodiment, the program 140 may include an operating system (OS) 142 to control one or more resources of the electronic device 101, middleware 144, or an application 146 executable in the OS 142. The OS 142 may include, for example, Android™, iOS™, Windows™, Symbian™, Tizen™, or Bada™. At least part of the program 140, for example, may be pre-loaded on the electronic device 101 during manufacture, or may be downloaded from or updated by an external electronic device (e.g., the electronic device 102 or 104, or the server 108) during use by a user.

The OS 142 may control management (e.g., allocating or deallocation) of one or more system resources (e.g., process, memory, or power source) of the electronic device 101. The OS 142, additionally or alternatively, may include one or more driver programs to drive other hardware devices of the electronic device 101, for example, the input module 150, the sound output module 155, the display module 160, the audio module 170, the sensor module 176, the interface 177, the haptic module 179, the camera module 180, the power management module 188, the battery 189, the communication module 190, the subscriber identification module 196, or the antenna module 197.

The middleware 144 may provide various functions to the application 146 such that a function or information provided from one or more resources of the electronic device 101 may be used by the application 146. The middleware 144 may include, for example, an application manager 201, a window manager 203, a multimedia manager 205, a resource manager 207, a power manager 209, a database manager 211, a package manager 213, a connectivity manager 215, a notification manager 217, a location manager 219, a graphic manager 221, a security manager 223, a telephony manager 225, or a voice recognition manager 227.

The application manager 201, for example, may manage the life cycle of the application 146. The window manager 203, for example, may manage one or more graphical user interface (GUI) resources that are used on a screen. The multimedia manager 205, for example, may identify one or more formats to be used to play media files, and may encode or decode a corresponding one of the media files using a codec appropriate for a corresponding format selected from the one or more formats. The resource manager 207, for example, may manage the source code of the application 146 or a memory space of the memory 130.The power manager 209, for example, may manage the capacity, temperature, or power of the battery 189, and determine or provide related information to be used for the operation of the electronic device 101 based at least in part on corresponding information of the capacity, temperature, or power of the battery 189. According to an embodiment, the power manager 209 may interwork with a basic input/output system (BIOS) (not shown) of the electronic device 101.

The database manager 211, for example, may generate, search, or change a database to be used by the application 146. The package manager 213, for example, may manage installation or update of an application that is distributed in the form of a package file. The connectivity manager 215, for example, may manage a wireless connection or a direct connection between the electronic device 101 and the external electronic device. The notification manager 217, for example, may provide a function to notify a user of an occurrence of a specified event (e.g., an incoming call, message, or alert). The location manager 219, for example, may manage locational information on the electronic device 101. The graphic manager 221, for example, may manage one or more graphic effects to be offered to a user or a user interface related to the one or more graphic effects.

The security manager 223, for example, may provide system security or user authentication. The telephony manager 225, for example, may manage a voice call function or an image call function provided by the electronic device 101. The voice recognition manager 227, for example, may transmit a user's voice data to the server 108, and receive, from the server 108, a command corresponding to a function to be executed on the electronic device 101 based at least in part on the voice data, or text data converted based at least in part on the voice data. According to an embodiment, the middleware 244 may dynamically delete some existing components or add new components. According to an embodiment, at least part of the middleware 144 may be included as part of the OS 142 or may be implemented as another software separate from the OS 142.

The application 146 may include, for example, a home 251, dialer 253, short message service (SMS)/multimedia messaging service (MMS) 255, instant message (IM) 257, browser 259, camera 261, alarm 263, contact 265, voice recognition 267, email 269, calendar 271, media player 273, album 275, watch 277, health 279 (e.g., for measuring the degree of workout or biometric information, such as blood sugar), or environmental information 281 (e.g., for measuring air pressure, humidity, or temperature information) application. According to an embodiment, the application 146 may further include an information exchanging application (not shown) that is capable of supporting information exchange between the electronic device 101 and the external electronic device. The information exchange application, for example, may include a notification relay application adapted to transfer designated information (e.g., a call, message, or alert) to the external electronic device or a device management application adapted to manage the external electronic device. The notification relay application may transfer notification information corresponding to an occurrence of a specified event (e.g., receipt of an email) at another application (e.g., the email application 269) of the electronic device 101 to the external electronic device. Additionally or alternatively, the notification relay application may receive notification information from the external electronic device and provide the notification information to a user of the electronic device 101.

The device management application may control the power (e.g., turn-on or turn-off) or the function (e.g., adjustment of brightness, resolution, or focus) of the external electronic device or some component thereof (e.g., a display module or a camera module of the external electronic device). The device management application, additionally or alternatively, may support installation, delete, or update of an application running on the external electronic device.

An electronic device (e.g., the electronic device 101 in FIG. 1 or the electronic device 101 in FIG. 2) equipped with a camera module (e.g., the camera module 180 in FIG. 1) may edit a basic video (or image) using at least one function among filter, tone, crop, face correction, auto correction, dual mode filter, sticker, and pen, after capturing the basic video (or image). When attempting to re-edit an encoded video (or image) to which an editing effect has been applied, the electronic device may not be able to remove the already applied editing effect and thus may need to add a new editing function to the edited video (or image).

To address the problem of having to add a new editing function to an edited video (or image) because the already applied editing effect may not be removed, the electronic device may separately store the original video (or image) prior to the application of the editing effect. In the disclosure, a function of enabling the electronic device to re-edit a video (or image) using a stored original video (or image) and restore the original video (or image) may be referred to as non-destructive editing (or a non-destructive editing function).

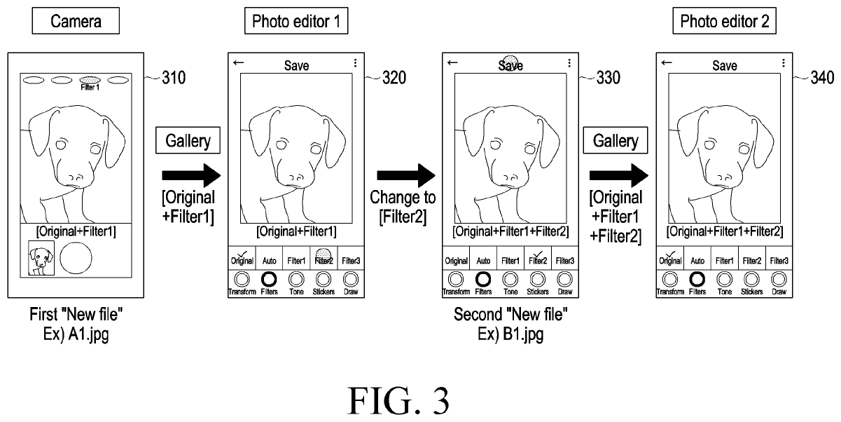

FIG. 3 is a diagram illustrating an example of not applying the non-destructive editing function in an electronic device according to various embodiments.

Referring to FIG. 3, an electronic device (e.g., the electronic device 101 in FIG. 1 or the electronic device 101 in FIG. 2) including a camera module (e.g., the camera module 180 in FIG. 1) may capture an original image 310 in response to a user input, and generate a first edited image 320 by applying a first filter (filter1) (e.g., a warm filter) effect to the original image 310 through an editing application (e.g., gallery application). For example, the original image 310 may be stored with a file name such as A1.jpg in the electronic device.

When the electronic device does not apply the non-destructive editing function during image editing, it may generate a second edited image 330 by applying a second filter (e.g., lolli filter) effect to the first edited image 320 to which the first filter (e.g., warm filter) effect has been applied. For example, the second edited image 330 may be stored with a file name such as B1.jpg, which is different from the file name of the original image 310, in the electronic device.

When the electronic device does not apply the non-destructive editing function during image editing, the electronic device may not restore the original image 310 by removing the first filter (e.g., warm filter) effect that has already been applied from the first edited image 320. When the electronic device intends to apply the second filter (e.g., lolli filter) effect to the original image 310, the electronic device may have to apply the second filter (e.g., lolli filter) effect to the first edited image 320, instead of the original image 310.

The electronic device may edit and/or manage a third edited image 340 in which the first filter (e.g., warm filter) effect and the second filter (e.g., lolli filter) effect have been applied to the original image 310 through the editing application (e.g., gallery application).

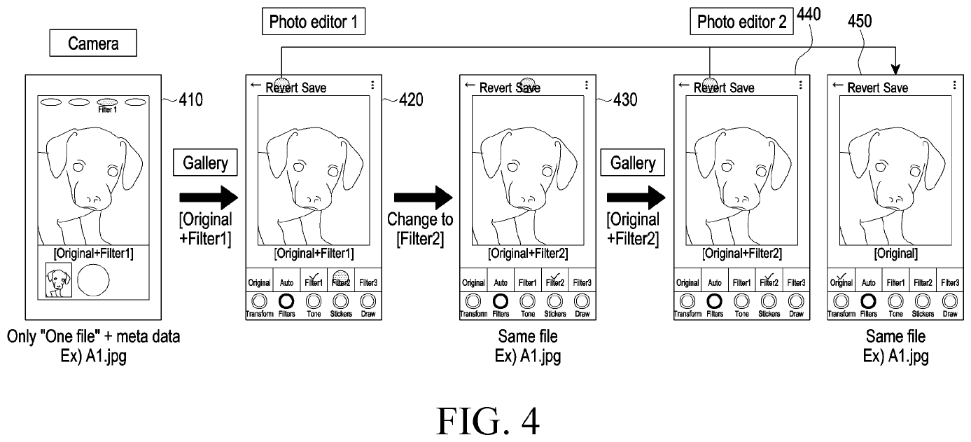

FIG. 4 is a diagram illustrating an example of applying the non-destructive editing function in an electronic device according to various embodiments.

Referring to FIG. 4, an electronic device (e.g., the electronic device 101 in FIG. 1 or the electronic device 101 in FIG. 2) equipped with a camera module (e.g., the camera module 180 in FIG. 1) may capture an original image 410 in response to a user input. For example, the original image 410 may be stored together with metadata, with a file name such as A1.jpg in the electronic device. For example, the original image 410 may be stored in a specified area of memory (e.g., the memory 130 in FIG. 1) of the electronic device 101. For example, the original image 410 may be stored in a specified path or a specified area (e.g., a secure area, a system area, or a hidden area) included in the memory 130. The electronic device may generate a first edited image 420 by applying a first filter (e.g., warm filter) effect to the original image 410 through an editing application (e.g., gallery application).

When the electronic device applies the non-destructive editing function during image editing, it may remove the first filter (e.g., warm filter) effect that has already been applied from the first edited image 420 and restore the original image 410. When the electronic device intends to apply a second filter (e.g., lolli filter) effect to the original image 410, the electronic device may generate a second edited image 430 by applying the second filter (e.g., lolli filter) effect to the original image 410. For example, the second edited image 430 may be stored with the same file name as the original image 410, such as A1.jpg, in the electronic device. For example, the second edited image 430 may be stored at a different position from that of the original image 410 in the memory 130. The second edited image 430 may be stored in a different path or a different area (e.g., a general area or an application area) from that of the original image 410.

The electronic device may edit and/or manage a third edited image 440 obtained by applying the second filter (e.g., lolli filter) effect to the original image 410 through the editing application (e.g., gallery application). The electronic device may remove the second filter (e.g., lolli filter) effect from the third edited image 440 and restore the original image 450 again. For example, the original image 450 may be stored with the same file name as the original image 410, such as A1.jpg, in the electronic device. For example, the original image 450 may be stored in the specified area of the memory (e.g., the memory 130 in FIG. 1) of the electronic device 101. For example, the original image 450 may be stored in the specified path or specified area (e.g., the secure area, the system area, or the hidden area) included in the memory 130. According to an embodiment, the image prior to editing, the edited image, and/or the restored original image may all be overwritten and used as a file having one media ID. According to an embodiment, the image prior to editing, the edited image, and/or the restored original image may be stored in a scoped storage area of a user area.

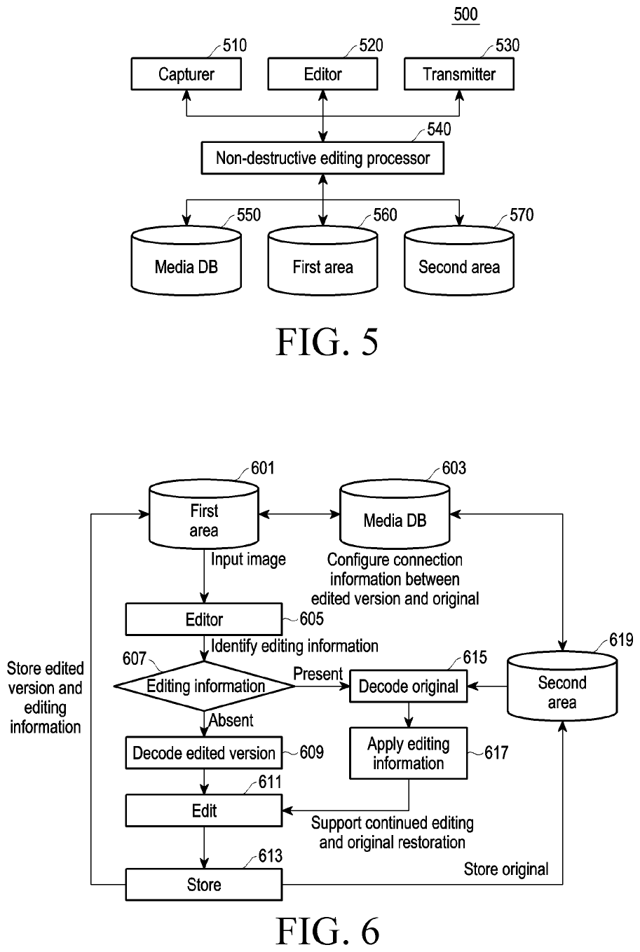

FIG. 5 is a diagram illustrating an example configuration of an electronic device including a non-destructive editing processor according to various embodiments.

Referring to FIG. 5, an electronic device 500 may include a capturer 510, an editor 520, a transmitter 530, a non-destructive editing processor (e.g., including processing circuitry) 540, a media database (DB) 550, a first storage (or hidden storage) 560, and a second storage (or scoped storage) 570. The electronic device 500 may be implemented as the electronic device 101 in FIG. 1 or the electronic device 101 in FIG. 2. According to an embodiment, at least one of the capturer 510, the editor 520, the transmitter 530, and/or the non-destructive editing processor 540 may be implemented within a processor (or at least one processor) (e.g., the processor 120 in FIG. 1). For example, at least one of the capturer 510, the editor 520, the transmitter 530, or the non-destructive editing processor 540 may include a software module (e.g., at least one command or program) executed by the processor, and in this case, an operation of the corresponding module may be understood as an operation of the processor 120. According to an embodiment, the first storage 560 and the second storage 570 may be included in one memory and logically separated areas (or storage areas). According to an embodiment, the first storage 560 and the second storage 570 may have logically different attributes.

The electronic device 500 may capture an image (or video) through the capturer 510, edit the image (or video) through the editor 520, and transmit the captured and/or edited image (or video) to an external electronic device through the transmitter 530.

The electronic device 500 may add (or apply) a new editing effect to an original video (or original image) through the non-destructive editing processor 540. The electronic device 500 may restore the original video (or image) by editing (e.g., applying a filter to or changing a filter for) a video (or image) through the non-destructive editing processor 540. The electronic device 500 may edit a video (or image) which has been edited through the non-destructive editing processor 540 and then stored.

The electronic device 500 may edit an image (or video) file by the editor and then store it in the first area 560 and/or the second area 570. The electronic device 500 may store the original image (or original video) in the first area 560, which is a hidden area inaccessible to the user. The electronic device 500 may store the edited image (or edited video) in the second area 570, together with editing information. According to an embodiment, the first area 560 may be located within a system storage.

When editing an image (or video) file, the electronic device 500 may decode an original image (or original video), and edit and/or store the decoded image (or decoded video). When the edited image (or edited video) is deleted, the electronic device 500 may delete an original image (or original video) unused any longer, after a specific time by analyzing the media DB 550 having an image information link between the first area 560 and the second area 570 through a specific program.

FIG. 6 is a diagram illustrating an example operation of a non-destructive editing processor according to various embodiments.

A non-destructive editing processor (e.g., the non-destructive editing processor 540 in FIG. 5) may obtain (or receive) an input image from a scoped storage 601 and identify editing information for the input image through an editor 605. The non-destructive editing processor may configure (e.g., generate or modify) connection information between an edited image (or edited video) and an original image (or original video) using a media DB 603.

The non-destructive editing processor may determine whether the editing information for the input image stored in the first area 601 exists (607). According to an embodiment, the first area 601 may be located within a scoped storage. According to an embodiment, when the editing information for the input image does not exist, the non-destructive editing processor may decode the edited image (or edited video) (609), edit the decoded image (or video) (611), and store the edited image (or video) (613). The non-destructive editing processor may store the edited version and the editing information in the first area 601 and store the original in a second area 619. According to an embodiment, the second area 619 is an area with restricted access and may be implemented as a system area or a secure area.

According to an embodiment, when the editing information for the input image exists, the non-destructive editing processor may obtain the original image from the second area 619 and decode the obtained original image (615). The non-destructive editing processor may apply (or add) the editing information to the decoded image (617) and support a continued editing and/or original restoration function for the input image. According to an embodiment, the editing information applied to the decoded image may include at least one of an applied filter, a filter application level, and/or tone and correction information.

Thereafter, the non-destructive editing processor may edit the decoded image (or video) (611) and store the edited image (or video) (613). The non-destructive editing processor may store the edited version and the editing information in the first area 601 and store the original in the second area 619.

According to an embodiment, an edited image (or video) may be transmitted between electronic devices. According to an embodiment, synchronization (or sync) and backup operations of edited images (or videos) may be performed by a plurality of electronic devices through a cloud (or server). According to an embodiment, as an edited image (or video) is transmitted together with an original image (or video), an electronic device may perform non-destructive editing on the image (or video) in succession to an external electronic device. According to an embodiment, original metadata may be transmitted together with the original image as one file or separate files. According to an embodiment, the original metadata may be transmitted together with the edited image. According to an embodiment, the original metadata may be stored and used in a file format within the electronic device, or in a string format (e.g., characters or text) within a cloud server or a media DB.

An original storage path for storing the original image (or video) may be configured and/or stored based on a path of the edited image (or video). Storage and/or acquisition of the original image (or video) may be determined based on the original path.

For example, the path of the edited version may be configured as “: storage/pictures/house.jpg”, and the storage path of the original may be configured as “: hidden storage/userid/storage/pictures/house.jpg”. In the original storage path, “hidden storage/userid” may be an address of a hidden area, and “storage/pictures/house.jpg” may be the path of the edited version.

When the original path based on the path of the edited version is used, the same file name may not exist in the same folder. Therefore, unlike within a single electronic device, during transmission between electronic devices or cloud synchronization (or sync), another original image with the same file name as that of the original may exist in another electronic device, or when the original is stored at a changed storage position, it may not be matched with the editing information, causing a non-destructive editing error which prevents and/or reduces continued non-destructive editing. In addition, due to dependency on a simply stored original path, it may be difficult to change a previous fixedly used original path during transmission and/or reception.

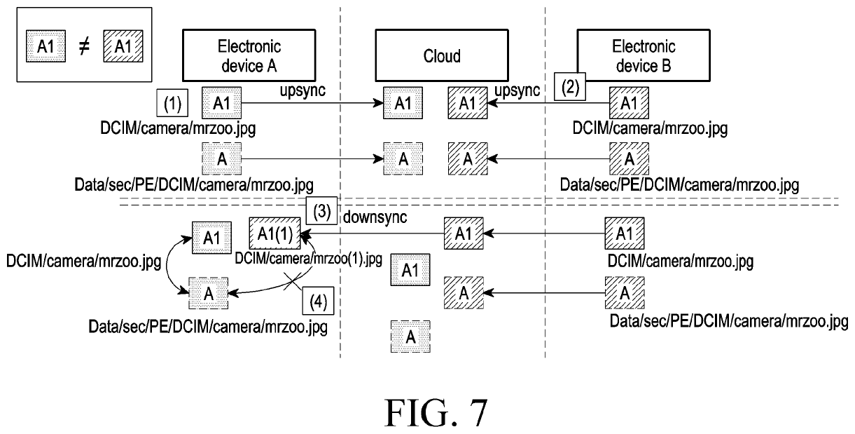

FIG. 7 is a diagram illustrating an example in which an error occurs when a plurality of electronic devices use the non-destructive editing function according to various embodiments.

Referring to FIG. 7, each of electronic device A and electronic device B may support a synchronization (or sync) function through a cloud (or one drive (OD)).

In an embodiment, electronic device A may capture an original image A and generate an edited image A1 by editing the original image A. The edited image A1 generated by electronic device A may be upsynced to the cloud. For example, the edited image A1 may be stored in a path “DCIM/camera/mrzoo.jpg”, and the original image A may be stored in a path “Data/sec/PE/DCIM/camera/mrzoo.jpg” based on the path of the edited image A1.

In an embodiment, electronic device B may capture the original image A and generate the edited image A1 by editing the original image A. The edited image A1 generated by electronic device B may be upsynced to the cloud. For example, the edited image A1 may be stored in the path “DCIM/camera/mrzoo.jpg”, and the original image A may be stored in the path “Data/sec/PE/DCIM/camera/mrzoo.jpg” based on the path of the edited image A1.

In an embodiment, the edited image Al upsynced from electronic device B to the cloud may be downsynced to electronic device A. Since an image with the same name already exists in the same path for the downsynced edited image A1, electronic device A may change the name of the downsynced edited image A1 to “A1(1)”. For example, the edited image A1(1) may be stored in a path “DCIM/camera/mrzoo(1).jpg” within electronic device A. Since electronic device A already keeps the original image A, it may not download the original image A from the cloud.

In an embodiment, when electronic device A re-edits the edited image A1(1), the original image A stored in electronic device A is in the same path but has a different size. Accordingly, it is not retrieved as the original and is edited as a new image, thereby causing an error.

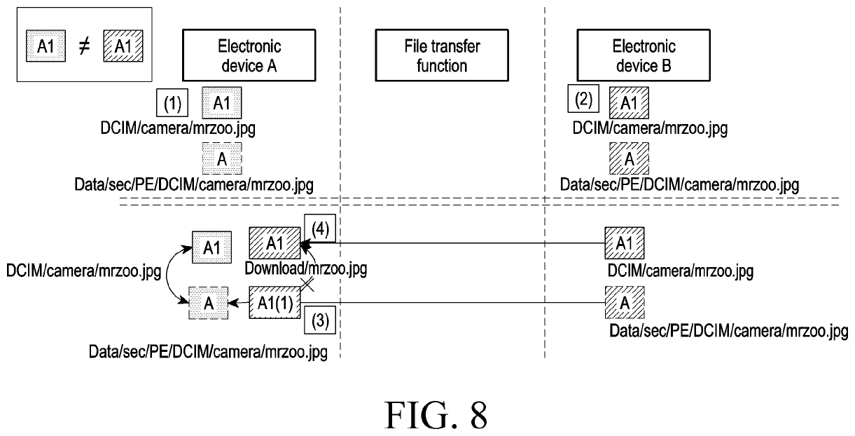

FIG. 8 is a diagram illustrating an example in which an error occurs when a plurality of electronic devices use the non-destructive editing function according to various embodiments.

Referring to FIG. 8, each of electronic device A and electronic device B may transmit and/or receive an image.

In an embodiment, electronic device A may capture the original image A, perform non-destructive editing on the original image A to create the edited image A1, and store the edited image A1. For example, the edited image A1 may be stored in the path “DCIM/camera/mrzoo.jpg”, and the original image A may be stored in the path “Data/sec/PE/DCIM/camera/mrzoo.jpg” based on the path of the edited image A1.

In an embodiment, electronic device B may capture the original image A, perform non-destructive editing on the original image A to create the edited image A1, and store the edited image A1. For example, the edited image A1 may be stored in the path “DCIM/camera/mrzoo.jpg”, and the original image A may be stored in the path “Data/sec/PE/DCIM/camera/mrzoo.jpg” based on the path of the edited image A1.

Although the edited image A1 non-destructively edited by electronic device A and the edited image A1 non-destructively edited by electronic device B are different images, they may have the same file path and name, and also have the same original folder path in the respective electronic devices. According to an embodiment, the edited image A1 non-destructively edited by electronic device A and the edited image A1 non-destructively edited by electronic device B may have the same path-based hash. According to an embodiment, the edited image A1 non-destructively edited by electronic device A and the edited image A1 non-destructively edited by electronic device B may have different sizes. According to an embodiment, the original path may be stored as meta information for non-destructive editing. According to an embodiment, the meta information may be included in metadata, and the metadata may be implemented in a specific format inside or outside an image file.

In an embodiment, the original image A transmitted from electronic device B to electronic device A through a file transfer function may be stored with the name changed to “A1(1)” because there is the original image A with the same name in the same path within electronic device A. According to an embodiment, since the edited version has different original information within electronic device A, it may be deleted by the processor (e.g., the processor 120 in FIG. 1 or a job scheduler) after a preset time (e.g., 24 hours). According to an embodiment, electronic device A may not download and/or store the original image A from electronic device B because there is already an original with the same name as the original image A in electronic device A.

In an embodiment, when electronic device A re-edits the edited image A1 transmitted from electronic device B to electronic device A through the file transfer function, the original image A stored in electronic device A is in the same path but the two images have different sizes. Accordingly, it may not be retrieved as the original and may be edited as a new image, thereby causing an error. The metadata of the edited version may have to be changed to connect the edited image A1, which has been transmitted from electronic device B to electronic device A through the transfer function (e.g., quick share), to the new original.

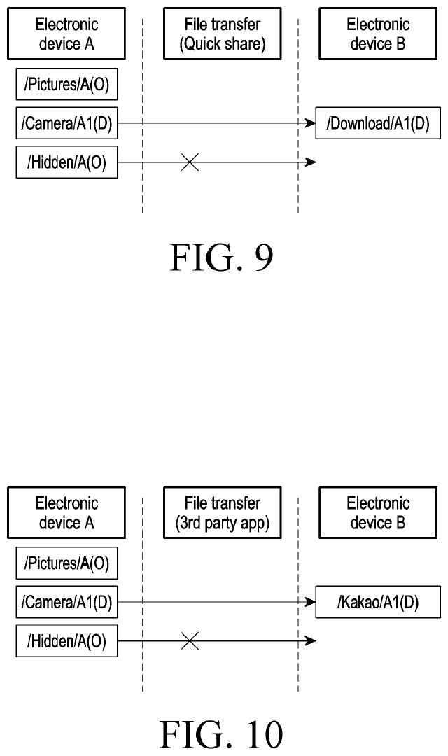

FIG. 9 is a diagram illustrating an example of transmitting an edited image through a file transfer function during non-destructive editing in an electronic device according to various embodiments.

When only an edited version of a non-destructively edited image (or video) is transmitted without an original, continued editing may not be performed because the electronic device may receive the actual original later from a synced server or another electronic device.

Referring to FIG. 9, when only an edited image (e.g., an image stored in a path/camera/A1(D)) is transmitted from electronic device A to electronic device B through the file transfer function (e.g., quick share), electronic device B may store the edited image, for example, in a path “/Download/A1(D)”. An original image stored in electronic device A (e.g., an image stored in a path/hidden/A(O)) may not be transmitted to electronic device B. Since the edited image received by electronic device B from electronic device A does not have the original, it may only operate as save as copy within electronic device B.

FIG. 10 is a diagram illustrating an example of transmitting an edited image through a third-party sharing application during non-destructive editing in an electronic device according to various embodiments.

Referring to FIG. 10, when only an edited image (e.g., an image stored in the path/camera/A1(D)) is transmitted from electronic device A to electronic device B through a third-party sharing application, electronic device B may store the edited image, for example, in a path “/Kakao/A1(D)”. An original image stored in electronic device A (e.g., an image stored in a path/hidden/A(O)) may not be transmitted to electronic device B through the third-party sharing application. Since the edited image received by electronic device B from electronic device A through the third-party sharing application does not have the original, it may only operate as save as copy within electronic device B.

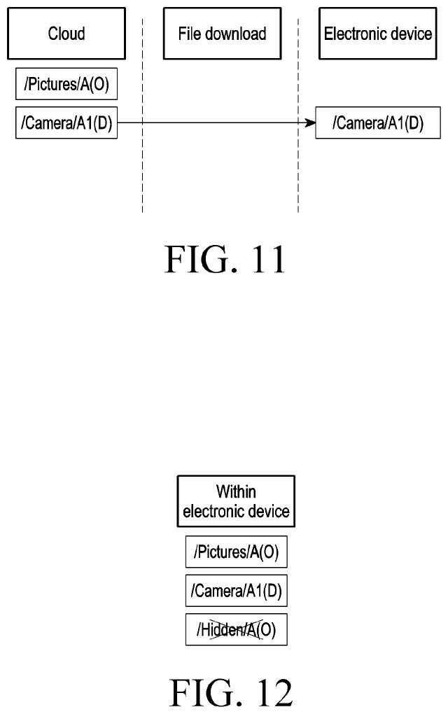

FIG. 11 is a diagram illustrating an example of receiving only an edited image from a cloud server during non-destructive editing in an electronic device according to various embodiments.

Referring to FIG. 11, when only an edited image (e.g., an image stored in a path/camera/A1(D)) is transmitted from a cloud server to an electronic device through file download, the electronic device may store the edited image, for example, in a path “/Camera/A1(D)”. Since the edited image downloaded by the electronic device from the cloud server does not have the original, it may only operate as save as copy within the electronic device.

According to an embodiment, in the case where only the edited image received by electronic device A through the third-party sharing application is upsynced to the cloud, when electronic device B downloads the edited image, the edited image may only operate as save as copy, because there is no original.

FIG. 12 is a diagram illustrating an example in which an original image is deleted and only an edited image remains during non-destructive editing in an electronic device according to various embodiments.

Referring to FIG. 12, an edited image (e.g., an image stored in a path/camera/A1(D)) and an original image (e.g., an image stored in a path/hidden/A1(O)) may have existed within the electronic device, but the original image may have been deleted and only the edited image may remain. In this case, since the specific edited image within the electronic device does not have the original, it may only operate as save as copy within the electronic device.

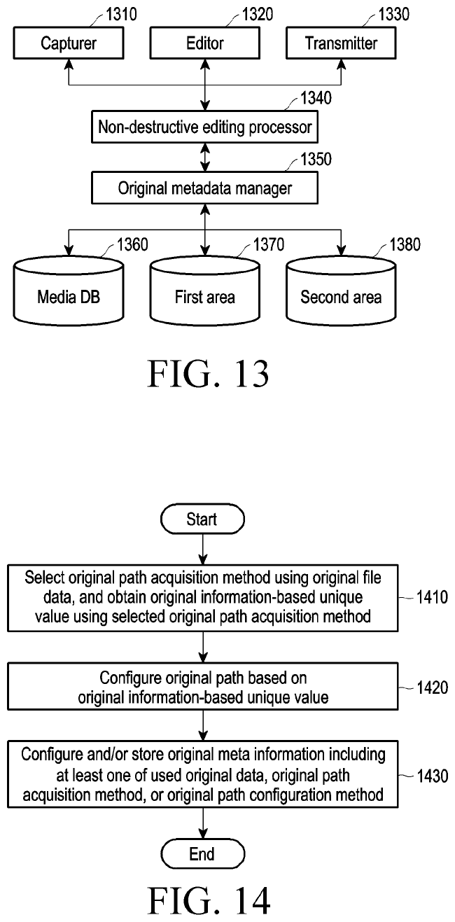

FIG. 13 is a diagram illustrating an example configuration of an electronic device including a non-destructive editing processor and an original metadata manager according to various embodiments.

Referring to FIG. 13, an electronic device 1300 may include a capturer 1310, an editor 1320, a transmitter 1330, a non-destructive editing processor (e.g., including processing circuitry) 1340, an original metadata manager 1350, a media DB 1360, a first area 1370, and a second area 1380. The electronic device 1300 may be implemented as the electronic device 101 in FIG. 1 or the electronic device 101 in FIG. 2. According to an embodiment, at least one of the capturer 1310, the editor 1320, the transmitter 1330, the non-destructive editing processor 1340, or the original metadata manager 1350 may be implemented within a processor (or at least one processor) (e.g., the processor 120 in FIG. 1). For example, it may be a software module executed by the processor 120. According to an embodiment, the first area 1370 and the second area 1380 may be included in one memory and logically (e.g., virtual memory addresses) or physically (e.g., physical memory addresses) separated areas (or storage areas). According to an embodiment, the memory may include non-volatile memory. According to an embodiment, the first area 1370 and the second area 1380 may have different attributes. According to an embodiment, the first area 1370 may be configured as a secure area, a system area, or a hidden area, and the second area 1380 may be configured as a general area.

The electronic device 1300 may capture an image (or video) through the capturer 1310, edit the image (or video) through the editor 1320, and transmit the captured and/or edited image (or video) to an external electronic device through the transmitter 1330.

The electronic device 1300 may remove an editing effect already applied to an image (or video) through the non-destructive editing processor 1340 and add a new editing effect to an original image (or original video). The electronic device 1300 may re-edit the image (or video) using the original image (or video) and restore the original image (or video) through the non-destructive editing processor 540.

The electronic device 1300 may configure a path for storing the original image (or video) required for non-destructive editing and manage the path of the original image (or video) through the original metadata manager 1350. The original metadata manager 1350 may generate a unique value using file data of the original video (or image) and configure a unique original path for the original video (or image) using the unique value. The original metadata manager 1350 may prevent and/or reduce generation of duplicate original paths for different videos (or images) and avoid incorrect matching between the edited version and the original during non-destructive editing by storing the original video (or image) in the path generated using the unique value. The original metadata manager 1350 may enable identification whether the original matched with the edited version is the actual original of the edited version, and when a plurality of electronic devices perform non-destructive editing, all edited versions may be replaced with one original, thereby reducing the use of memory capacity in the electronic device.

According to an embodiment, a transmitting electronic device, a server, and/or a receiving electronic device may identify an original path acquisition method and an original path configuration method for a specific video (or image) using original metadata information. According to an embodiment, the transmitting electronic device, the server, and/or the receiving electronic device may request an original from a device that transmitted an edited version to detect the original of non-destructively edited versions, using the original metadata information, and the device that transmitted only the edited version may detect and transmitted the requested original. According to an embodiment, an electronic device having only an edited version may obtain and/or store an original path matching the edited version through the original metadata manager 1350, when obtaining an original.

According to an embodiment, an original path for a specific video (or image) may be generated based on a unique value, unique_value generated using internal file data of an original video (or image) (e.g., in the form of hidden folder/unique_value.extension). According to an embodiment, the original path for the specific video (or image) may be generated based on a first unique value, unique_valuel and a second unique value, unique_value2 generated using the internal file data of the original video (or image) (e.g., in the form of hidden folder/unique_value1/unique_value2.extension).

For example, the original path for the specific video (or image) may be configured in the form of “/data/sec/photoeditor/0/0a185b0a13622aa259588689f1b2b8499826ca0bed128f4c21ee4c49287d cee4.jpg”. For example, the original path for the specific video (or image) may be configured in the form of “/data/sec/photoeditor/0/0a185b0a13622aa259588689f1b2b849982/9826ca0bed128f4c21ee4c49 287dcee4.jpg”.

According to an embodiment, the unique value may be generated using the internal file data of the original video (or image) in various ways, and a used unique value generation method and original path configuration method may be stored as ‘original metadata’ in the edited version (or in a file format within a terminal, within a cloud server, and/or within a media DB). According to an embodiment, in the case of a large file such as a video file, the unique value may be obtained using the file data of the original video (or image) in consideration of a value acquisition time.

According to an embodiment, the unique value may be generated through a file binary hash technique for the original video (or image). According to an embodiment, the unique value may be generated through a file binary hash technique using media item header information for the original video (or image). According to an embodiment, the unique value may be generated based on the file data and hashing technique of the original video (or image), and the file data may include a file size, the number of frames, and/or a resolution. According to an embodiment, the unique value may be generated through a hashing technique for a combination of the file size, the number of frames, and the resolution.

According to an embodiment, the unique value may be generated through a binary hashing technique of original rescaled content. According to an embodiment, the unique value may be generated through a hashing technique of data values within a specific range around a median size value for the original video (or image). According to an embodiment, the unique value may be generated through a combination of at least one of the above techniques.

According to an embodiment, the original path using the unique value may be configured in the form of “Hidden folder/unique value1_filesize.extension”. According to an embodiment, the original path using the unique value may be configured in the form of “Hidden folder/unique value1_unique_value2.extenstion”. According to an embodiment, the original path using the unique value may be configured in the form of “Hidden folder/Unique value1/unique value2.extension”.

According to an embodiment, when the original path is obtained, the unique value generated using the internal file data of the original video (or image) may be used as it is, and metadata may be configured by configuring a method of creating a unique value in an interpreter manner in the form of a method.

According to an embodiment, original metadata managed by the original metadata manager 1350 may include an original path configuration method using the generated unique value and connection information between the original and the edited version. According to an embodiment, the original metadata may be stored in the edited version (or a server with a matched image or a media DB) in the form of metadata.

According to an embodiment, the receiving electronic device (or the transmitting electronic device) may identify the original metadata and determine the original for the edited version through the same original path method and original path configuration. According to an embodiment, the receiving electronic device (or the transmitting electronic device) may autonomously configure and obtain the original path of the stored edited version. According to an embodiment, when there is no original metadata, default original metadata may be defined, and a default unique value method and a default path configuration method may be used.

The original metadata manager 1350 may be implemented within at least one of the transmitting electronic device, the server, or the receiving electronic device. It may be possible to form original metadata and use it to perform a transmission/sync operation in a new original configuration method in other devices.

The electronic device 1300 may edit an image (or video) file in each editor and then store it in a first area 1370 and/or a second area 1380. The electronic device 1300 may store an original image (or original video) in the first area 1370, which is a hidden area inaccessible to the user. The electronic device 1300 may store the edited image (or edited video) in the second area 1380, together with editing information.

When re-editing the image (or video) file, the electronic device 1300 may decode the original image (or original video) and apply the editing information to allow continued editing. When the edited image (or edited video) is deleted, the electronic device 1300 may delete the original image (or original video) which is not used any longer after a specific time by analyzing the media DB 1360 having an image information link between the first area 1370 and the second area 1380 through a specific program.

FIG. 14 is a flowchart illustrating an example operation of configuring original meta information during non-destructive editing in an electronic device according to various embodiments.

An electronic device (e.g., the electronic device 1300 in FIG. 13) may select an original path acquisition method and configure an original path during non-destructive editing of an image (or video). According to an embodiment, the electronic device may include an original metadata manager (e.g., the original metadata manager 1350 in FIG. 13) for generating and/or managing original metadata for an image (or video).

Referring to FIG. 14, in operation 1410, the electronic device may select an original path acquisition method using original file data and obtain an original information-based unique value using the selected original path acquisition method. The original path acquisition method may include a file binary hash technique, a file binary hash technique using media item header information, a combination hashing technique of original file information (e.g., a size, the number of frames, and/or a resolution), a binary hashing technique of rescaled original content, a hashing technique of data values within a specific range around a median size value for the original video (or image), or a combination of at least one of these techniques.

In operation 1420, the electronic device may configure an original path based on the original information-based unique value. According to an embodiment, the electronic device may obtain a plurality of unique values and configure an original path using some or all of the plurality of unique values. The electronic device may store an original file in the original path using the obtained unique value.

In operation 1430, the electronic device may configure and/or store original meta information including at least one of the used original data, original path acquisition method, or original path configuration method. According to an embodiment, the electronic device may configure the original meta information to be included in an edited version. According to an embodiment, the meta information may be information included in metadata (or a data format).

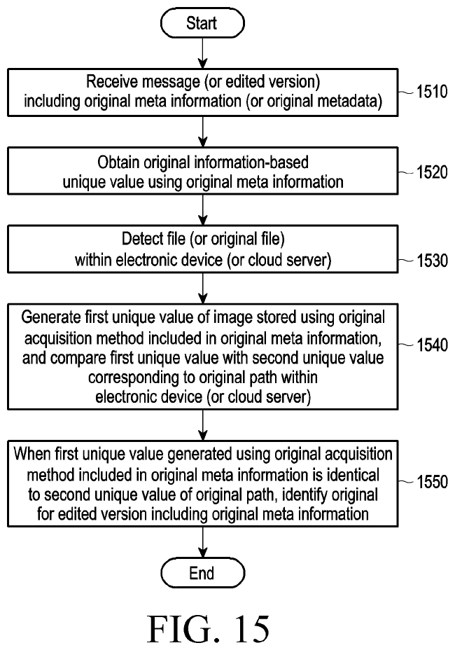

FIG. 15 is a flowchart illustrating an example operation of searching for an original file using original meta information in an electronic device or a server according to various embodiments.

Referring to FIG. 15, in operation 1510, an electronic device (or cloud server) holding an original file may receive a message (or edited version) including original meta information (or original metadata). According to an embodiment, the electronic device (or cloud server) may parse the original meta information and analyze and/or classify the original meta information.

In operation 1520, the electronic device (or cloud server) may obtain an original information-based unique value using the original meta information.

In operation 1530, the electronic device (or cloud server) may search for a file (or original file) within the electronic device (or cloud server).

In operation 1540, the electronic device (or cloud server) may generate a first unique value of an image stored using an original acquisition method included in the original meta information and compare it with a second unique value corresponding to an original path within the electronic device (or cloud server).

In operation 1550, when the first unique value generated using the original acquisition method included in the original meta information matches the second unique value of the original path, the electronic device (or cloud server) may identify the original for the edited version including the original meta information. The electronic device (or cloud server) may transmit the original including edited meta information to a transmitting side.

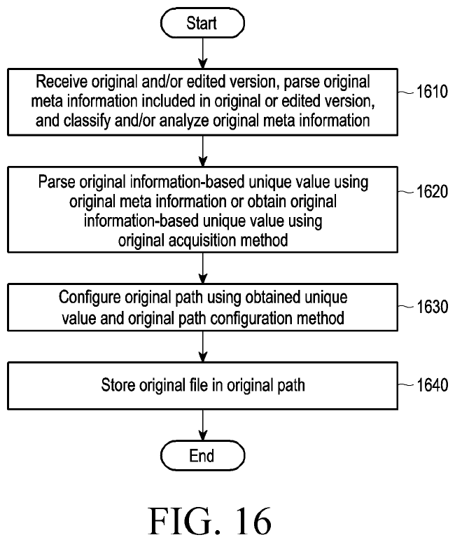

FIG. 16 is a flowchart illustrating an example operation of obtaining an original path and storing an original file in an electronic device according to various embodiments.

Referring to FIG. 16, in operation 1610, the electronic device may receive an original and/or an edited version, and parse, classify, and/or analyze original meta information included in the original or the edited version.

In operation 1620, the electronic device may parse an original information-based unique value using the original meta information or obtain the original information-based unique value using an original acquisition method.

In operation 1630, the electronic device may configure an original path using the obtained unique value and an original path configuration method.

In operation 1640, the electronic device may store an original file in the original path. The electronic device may complete matching between the edited version and the original path and perform non-destructive editing.

In the disclosure, an edited version and an original may be accurately matched after non-destructive editing/saving by configuring a unique original path using an original file-based unique value and storing the original in the corresponding original path. When the original paths of edited versions are the same, it may be determined that the edited versions were generated using the same original.

According to an embodiment, when non-destructive editing is performed on different media with the same file name in two different electronic devices, a conventional method results in different media originals and the same original path in both electronic devices. However, an original path generated based on original media data of the disclosure is a unique original path according to each used media. The original media data-based original path of the disclosure may enable accurate connection matching between an edited version and an original, when transmitting and/or receiving a non-destructively edited original/edited version through wireless transmission, data transmission, or a cloud.

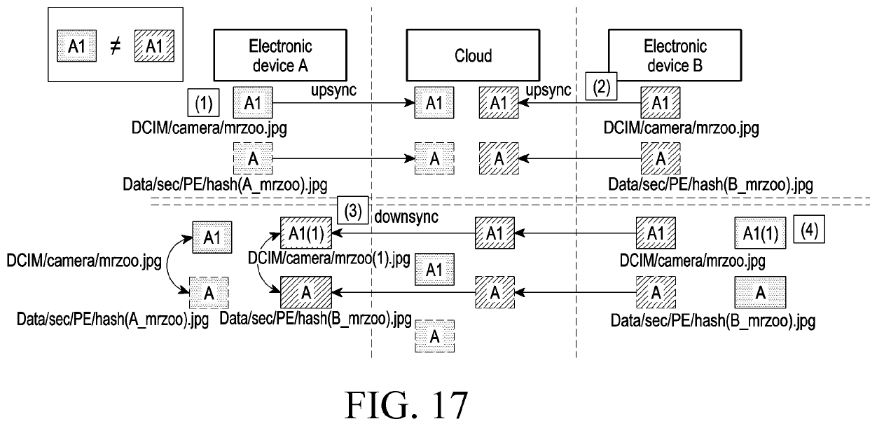

FIG. 17 is a diagram illustrating an example operation of using an original file information-based path during non-destructive editing in a plurality of electronic devices according to various embodiments.

Referring to FIG. 17, each of electronic device A and electronic device B may support a synchronization (or sync) function through a cloud (or one drive (OD)).

In an embodiment, electronic device A may capture an original image A and generate an edited image A1 by editing the original image A. The edited image A1 edited by electronic device A may be upsynced to the cloud. For example, the edited image A1 may be stored in a path “DCIM/camera/mrzoo.jpg”, and the original image A may be stored in a path “Data/sec/PE/hash(A_mrzoo).jpg” based on a binary hash.

In an embodiment, electronic device B may capture the original image A and generate the edited image A1 by editing the original image A. The edited image A1 edited by electronic device B may be upsynced to the cloud. For example, the edited image A1 may be stored in the path “DCIM/camera/mrzoo.jpg”, and the original image A may be stored in a path “Data/sec/PE/hash(B_mrzoo).jpg” based on the binary hash.

In an embodiment, the edited image A1 upsynced from electronic device B to the cloud (OD) may be downsynced to electronic device A. Since the edited image A1 with the same name already exists in the same path for the edited image A1 downsynced to external device A, the name of the downsynced edited image A1 may be changed to “A1(1)”. For example, the edited image A1(1) may be stored in a path “DCIM/camera/mrzoo(1).jpg” within electronic device A.

In an embodiment, electronic device A may download the original image A of electronic device B, which has a different path configuration from the original image A stored in electronic device A, from the cloud. The original image A of electronic device B downloaded by electronic device A from the cloud may be implemented with a path/file name “DCIM/camera/hash(B_mrzoo).jpg”.

In an embodiment, electronic device A may independently edit each of the edited image A1 and the edited image A1(1), and the edited versions may be equally synchronized (or synced) to electronic device B.

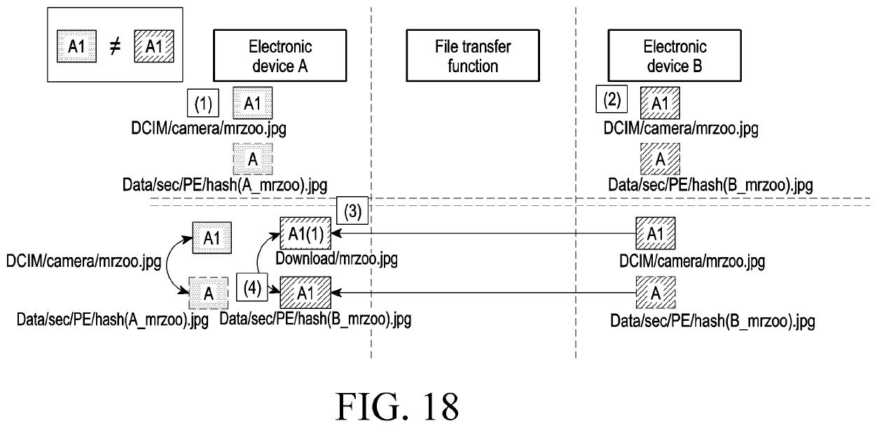

FIG. 18 is a diagram illustrating an example operation of using an original file information-based path during non-destructive editing in a plurality of electronic devices according to various embodiments.

In an embodiment, electronic device A may capture the original image A and generate the edited image A1 by editing the original image A. For example, the edited image A1 may be stored in the path “DCIM/camera/mrzoo.jpg”, and the original image A may be stored in the path “Data/sec/PE/hash(A_mrzoo).jpg” based on the binary hash.

In an embodiment, electronic device B may capture the original image A and generate the edited image A1 by editing the original image A. For example, the edited image A1 may be stored in the path “DCIM/camera/mrzoo.jpg”, and the original image A may be stored in the path “Data/sec/PE/hash(B_mrzoo).jpg” based on the binary hash.

In an embodiment, electronic device A may download the edited image A1 transmitted from electronic device B. For example, the edited image Al downloaded from electronic device B may be stored in the path “Download/mrzoo.jpg” within electronic device A.

In an embodiment, electronic device A may download the original image A of electronic device B, which has a different path configuration from the original image A stored in electronic device A, through the file transfer function. The original image A of electronic device B downloaded by electronic device A may be implemented with the path/file name “DCIM/camera/hash(B_mrzoo).jpg”.

In an embodiment, electronic device A may independently edit each of the edited image A1 of electronic device A and the edited image A1 of electronic device B, and the edited version may be transmitted to electronic device B. Electronic device B may perform non-destructive editing on the received edited version without any other changes.

According to an embodiment, a method for obtaining an original file may be needed to maintain non-destructive editing continuity in an electronic device that has only an edited version without an original. When an electronic device having only an edited version requests an original file from another electronic device (or server) keeping the original, the other electronic device (or server) keeping the original may search for the correct original matching the edited version using original meta information including a unique value representing original information. The original received and/or synced in the electronic device having only the edited version may have an original path configured through an original metadata manager and be stored in a path matching the edited version, thereby enabling continuous non-destructive editing.

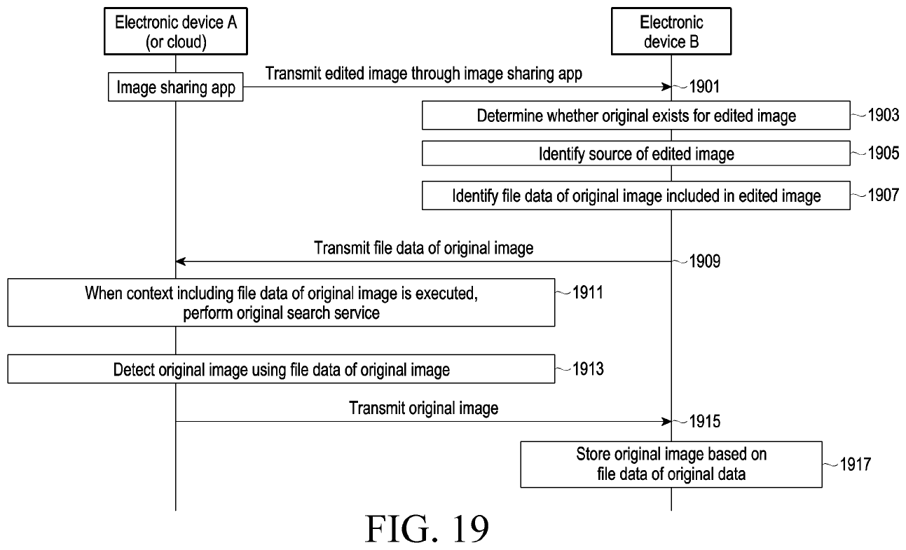

FIG. 19 is a signal flow diagram illustrating an example operation of requesting an original file in an electronic device having only an edited file according to various embodiments.

Referring to FIG. 19, in operation 1901, electronic device A (or a cloud) may transmit an edited image to electronic device B through an image sharing app. For example, the image sharing app may be implemented as a message, quick share, or a cloud application. In operation 1903, electronic device B may execute an original search service app and determine whether there is an original for the edited image. For example, the original search service app may be supported by the image sharing app, supported by an editor or gallery, or supported by an individual service.

In operation 1905, electronic device B may identify a source of the edited image. Electronic device B may identify an electronic device from which the edited image was transmitted and/or an application through which the edited image was transmitted. According to an embodiment, electronic device B may identify the source of the edited image by identifying a watermark or DRM for the source on the edited image, when downloading it. According to an embodiment, when there is no watermark or DRM for the source during downloading of the edited image in electronic device B, electronic device B may add a source to the edited image by a watermark when downloading the edited image.

In operation 1907, electronic device B may identify file data of an original image included in the edited image. According to an embodiment, the file data of the original image may include original hash information, original size information, and/or the number of frames, and/or a resolution. In operation 1909, electronic device B may transmit the file data of the original image to electronic device A (or the cloud) through the image sharing app.

In operation 1911, when a context including the file data of the original image received through the image sharing app is executed, electronic device A (or the cloud) may perform an original search service. In operation 1913, electronic device A (or the cloud) may search for the original image using the file data of the original image. According to an embodiment, electronic device A (or the cloud) may sort a binary hashing table and/or sizes and calculate a unique hash to search for the original image using the file data of the original image.

In operation 1915, electronic device A (or the cloud) may transmit the original image to electronic device B through the image sharing app. According to an embodiment, electronic device A (or the cloud) may transmit the original image and metadata of the original image together to electronic device B through the image sharing app.

In operation 1917, electronic device B may store the original image within the device based on the file data of the original data. According to an embodiment, electronic device B may configure a path for storing the original image based on the original hash information and/or original size information included in the file data, and store the original image in the path. For example, electronic device B may store the original in “hidden prefix directory/unique hash.extension”.

According to an embodiment, electronic device A (or the cloud) may search both an original file storage space and a user file storage space to detect an image corresponding to the original hash. According to an embodiment, the original may be stored one-to-one in the cloud, and the same original may exist in another space. According to an embodiment, the cloud may detect the image corresponding to the original hash by searching all file storage spaces.

According to an embodiment, an electronic device having only an edited version may request an original from another electronic device (or server). When there is no original for the edited version, creating a new original for the edited version may cause an editing error, and editing the edited version without the original by saving it as a copy under a different name may prevent and/or reduce continuous non-destructive editing. According to an embodiment, all media items may hash file binary or specific unique data during media scan or job scheduling to configure a unique hash table (e.g., binary hash). According to an embodiment, the file name of the original copied to the hidden area after editing and saving may be stored in an original data-based original path through the original metadata manager. According to an embodiment, when a unique value using an original path configuration method is identical to a unique value of a specific file, the two files may be identified as the same item.

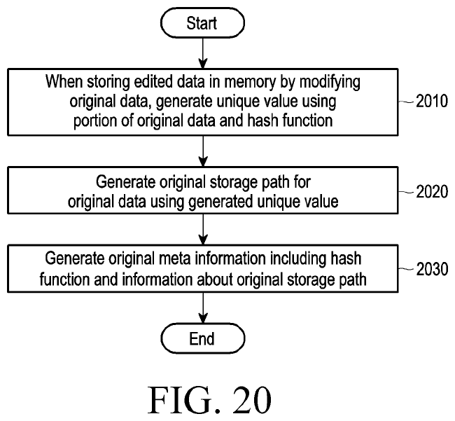

FIG. 20 is a flowchart illustrating an example operation of an electronic device according to various embodiments.

Referring to FIG. 20, in operation 2010, when an electronic device (101 in FIG. 1 or 1300 in FIG. 13) modifies original data and stores the edited data in memory, it may generate a unique value using a portion of the original data (or information related to the original data) and a hash function. In operation 2020, the electronic device may generate an original storage path for the original data using the generated unique value. In operation 2030, the electronic device may generate original meta information including the hash function and information about the original storage path. Memory (130 in FIGS. 1 or 1370 and 1380 in FIG. 13) included in an electronic device (101 in FIG. 1 or 1300 in FIG. 13) may store instructions that, when executed by a processor (120 in FIGS. 1 or 1340 and 1350 in FIG. 13), enable the electronic device to generate a unique value using a portion of original data (or information related to the original data) and a hash function, when the edited data obtained by modifying the original data is stored in the memory. The memory may store instructions that, when executed by the processor, enable the electronic device to generate an original storage path for the original data using the generated unique value. The memory may store instructions that, when executed by the processor, enable the electronic device to generate original meta information including the hash function and information about the original storage path.

An electronic device (101 in FIGS. 1 and 1300 in FIG. 13) according to an example embodiment includes a first area (1370 in FIG. 13), a second area (1380 in FIG. 13), and at least one processor (120 in FIGS. 1, and 1340 and 1350 in FIG. 13) connected to the first area and the second area. When the electronic device stores edited data obtained by modifying original data in the second storage, the at least one processor may generate a unique value using a portion of the original data and a hash function. The at least one processor may generate an original storage path for the original data using the unique value. The at least one processor may generate original meta information including the hash function used for generating the unique value and information about the original storage path.

According to an embodiment, the at least one processor may control to configure the edited data including the original meta information and transmit the edited data to an external electronic device. According to an embodiment, the hash function may include file binary hash, combined hashing of file information about the original data, binary hashing of rescaled original data, or hashing of a value of a portion of the original data.

According to an embodiment, the first area may be included in a system storage of a hidden area inaccessible to a user and store the original data. According to an embodiment, the second area may store the edited data and editing information. According to an embodiment, the electronic device may further include a media DB including an image information link between the first area and the second area.

According to an embodiment, the at least one processor may generate a plurality of unique values using a portion of the original data (or information related to the original data) and the hash function. According to an embodiment, the at least one processor may generate the original storage path for the original data based on a combination of the plurality of unique values. According to an embodiment, the information about the original storage path may include information about a method for configuring the original storage path using the unique value. According to an embodiment, each of first edited data and second edited data having the same original storage path may be data edited based on the same original data corresponding to the same original storage path. According to an embodiment, third edited data and fourth edited data having different original storage paths may be data edited based on different original data.

A method of an electronic device (101 in FIGS. 1 and 1300 in FIG. 13) according to an example embodiment of the disclosure may include, when the electronic device including a first area (1370 in FIG. 13) and a second area (1380 in FIG. 13) stores edited data obtained by modifying original data in the second area may include generating a unique value using a portion of the original data and a hash function. The method of the electronic device may include generating an original storage path for the original data using the generated unique value. The method of the electronic device may include generating original meta information including the hash function used for generating the unique value and information about the original storage path.

In a non-transitory computer-readable storage medium storing at least one instruction according to an example embodiment of the disclosure, the at least one instruction, when executed by at least one processor, may enable an electronic device to perform a plurality of operations. The plurality of operations may include, when the electronic device including a first area (1370 in FIG. 13) and a second area 91380 in FIG. 13) stores edited data obtained by modifying original data in the second area, generating a unique value using a portion of the original data and a hash function. The plurality of operations may include generating an original storage path for the original data using the generated unique value. The plurality of operations may include generating original meta information including the hash function used for generating the unique value and information about the original storage path.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
at least one processor, comprising processing circuitry; and
memory storing instructions that, when executed by the at least one processor individually or collectively, cause the electronic device to:
based on storing edited data obtained by modifying original data in the memory, generate a unique value using information related to the original data and a hash function,
generate an original storage path for the original data using the generated unique value, and
generate original meta information including the hash function and information about the original storage path.

2. The electronic device of claim 1, wherein the electronic device is configured to:
generate the unique value by combining at least some of a size of the original data, a number of frames of the original data, or resolution information about the original data, or
generate the unique value by rescaling the original data and using at least a portion of the rescaled original data, or
generate the unique value using a portion of the original data within a set range.

3. The electronic device of claim 1, wherein the electronic device is configured to control to configure the edited data including the original meta information and transmit the edited data to an external electronic device.

4. The electronic device of claim 1, wherein the hash function includes file binary hash, combined hashing of file information about the original data, binary hashing of rescaled original data, or hashing of a value of a portion of the original data.

5. The electronic device of claim 1, wherein the memory includes a first area and a second area having logically different attributes,
wherein the first area includes a system storage of a hidden area inaccessible to a user and stores the original data, and
wherein the second area is configured to store the edited data and editing information.

6. The electronic device of claim 1, further comprising a media database including an image information link between the first area and the second area.

7. The electronic device of claim 1, wherein the electronic device is configured to:
generate a plurality of unique values using a portion of the original data and the hash function, and
generate the original storage path for the original data based on a combination of the plurality of unique values.

8. The electronic device of claim 1, wherein each of first edited data and second edited data having the same original storage path is data edited based on the same original data corresponding to the same original storage path.

9. The electronic device of claim 8, wherein third edited data and fourth edited data having different original storage paths are data edited based on different original data.

10. A method of operating an electronic device, comprising:
based on the electronic device storing edited data obtained by modifying original data in memory, generating a unique value using information related to the original data and a hash function;
generating an original storage path for the original data using the generated unique value; and
generating original meta information including the hash function and information about the original storage path.

11. The method of claim 10, further comprising:
generating the unique value by combining at least some of a size of the original data, a number of frames of the original data, or resolution information about the original data; or
generating the unique value by rescaling the original data and using at least a portion of the rescaled original data; or
generating the unique value using a portion of the original data within a set range.

12. The method of claim 10, further comprising:
configuring the edited data including the original meta information; and
transmitting the edited data to an external electronic device.

13. The method of claim 10, wherein the hash function includes file binary hash, combined hashing of file information about the original data, binary hashing of rescaled original data, or hashing of a value of a portion of the original data.

14. The method of claim 10, wherein the memory includes a first area and a second area having logically different attributes,
wherein the first area includes a system storage of a hidden area inaccessible to a user and stores the original data, and
wherein the second area is configured to store the edited data and editing information.

15. The method of claim 10, further comprising:
generating a plurality of unique values using a portion of the original data and the hash function; and
generating the original storage path for the original data based on a combination of the plurality of unique values.

16. The method of claim 10, wherein each of first edited data and second edited data having the same original storage path is data edited based on the same original data corresponding to the same original storage path.

17. The method of claim 16, wherein third edited data and fourth edited data having different original storage paths are data edited based on different original data.

18. A non-transitory computer-readable storage medium storing at least one instruction that, when executed by at least one processor, comprising processing circuitry, individually and/or collectively, of an electronic device, causes the electronic device to perform operations comprising:
based on the electronic device storing edited data obtained by modifying original data in memory, generating a unique value using information related to the original data and a hash function;
generating an original storage path for the original data using the generated unique value; and
generating original meta information including the hash function and information about the original storage path.

19. The non-transitory computer-readable storage medium of claim 18, wherein the operations further comprise:
generating the unique value by combining at least some of a size of the original data, a number of frames of the original data, or resolution information about the original data; or
generating the unique value by rescaling the original data and using at least a portion of the rescaled original data; or
generating the unique value using a portion of the original data within a set range.

20. The non-transitory computer-readable storage medium of claim 18, wherein the operations further comprise:
configuring the edited data including the original meta information; and
transmitting the edited data to an external electronic device.
